(19) United States
(12) Patent Application Publication
(10) Pub. No.: US 2025/0065402 A1
(43) Pub. Date: Feb. 27, 2025

(54) METAL POWDER MANUFACTURING SYSTEM

(71) Applicant: EML CO., LTD., Suwon-si (KR)

(72) Inventors: Eun Soo PARK, Yongin-si (KR); Joo Ho LEE, Hwaseong-si (KR); Chang Woo JEON, Suwon-si (KR); JongUk HWANG, Suwon-si (KR)

(73) Assignee: EML CO., LTD., Suwon-si (KR)

(21) Appl. No.: 18/813,347

(22) Filed: Aug. 23, 2024

(30) Foreign Application Priority Data
Aug. 23, 2023 (KR) 10-2023-0110752
May 27, 2024 (KR) 10-2024-0068525

(51) Int. Cl. B22F 9/08

(52) U.S. Cl. CPC B22F 9/082; B22F 2009/0836; B22F 2009/0848; B22F 2009/0888; B22F 2009/0892

(57) ABSTRACT

An ultrafine powder manufacturing system is described. The system comprises a tube made of ceramic or quartz and a fine nozzle integrally formed in the lower part of the tube, wraps the outside of the tube with an induction heater to melt a metal raw material supplied into the tube and cause it to flow through the nozzle, and supplies a spray gas through orifices arranged to surround the nozzle in a state spaced apart from the nozzle to spray the gas onto the flowing melt to manufacture ultrafine powder.

### CROSS-REFERENCE TO RELATED APPLICATION

This application claims the priority of Korean Patent Applications No. 10-2023-0110752 filed on Aug. 23, 2023, and 10-2024-0068525 filed on May 27, 2024 in the Korean Intellectual Property Office, the disclosure of both is incorporated herein by reference.

### SUMMARY OF THE INVENTION

The present invention relates to a technology for manufacturing metal fine powder.

### BACKGROUND OF THE INVENTION

There are two methods for manufacturing 3D printing powder: mechanical crushing and gas atomizer. However, the mechanical crushing method is not suitable for 3D printing because the powder has an angular shape and an uneven particle-size distribution.

Gas atomizers, Vacuum induction inert gas atomization (VIGA) (published Korean patent No. 10-2017-0062906), Electrode induction inert gas atomization (EIGA) (registered Korean patent No. 10-2304964), and Water inert gas atomization (WIGA) are known as fine powder manufacturing technologies. However, the ultrafine power yield of all of these is very low, less than 20 μm. In order to apply the metal 3D printing and MIM/Binder jet method, fine spherical powder is required (see FIG. 1), and a system to obtain ultrafine power of 20 μm or less with a high yield is required.

High-purity spherical powder is mainly manufactured by the EIGA (Electrode Induction Gas Atomization) method. The alloy powder for 3D printing manufactured by the EIGA process goes through a sorting process depending on the application. Powder of 45-150 μm is used for DED (Directed Energy Deposition), while powder of 10-45 μm is used for PBF (Powder Bed Fusion).

In particular, powder for PBF (Powder Bed Fusion) must have good fluidity of powder for uniform lamination, and an appropriate particle-size distribution of the powder is required. However, when making powder with a high-melting point (>1400° C.) metal in the powder manufacturing process by EIGA, uneven melting occurs as the diameter of the metal electrode increases, making powder manufacturing impossible due to short and contact between the electrode and the induction coil.

Korean Publication No. 10-2022-0007683 proposes a technology for manufacturing nickel-based alloy powder using the VIGA and EIGA methods. However, it does not describe the problem of uneven melting of high melting point metal electrodes.

The purpose of the present invention is to provide an ultrafine powder manufacturing system that can manufacture ultrafine metal (a concept including alloys) with a diameter of 20 μm or less with a high yield.

Another purpose of the present invention is to provide a metal electrode supply device that can solve the problem of uneven melting of a metal electrode in manufacturing high melting point metal powder using the EIGA method.

The ultrafine powder manufacturing system of the present invention comprises a tube made of ceramic or quartz and a fine nozzle integrally formed in the lower part of the tube, wraps the outside of the tube with an induction heater to melt the metal raw material supplied inside the tube and cause it to flow through a nozzle, and supplies the injection gas through orifices arranged spaced apart from the nozzle and surrounding the nozzle, thereby injecting the gas into the melt flowing from the nozzle to manufacture ultrafine powder with a high yield.

In the above, the metal material supplied through the tube may include a stick type, powder, or piece.

If the metal material supplied through the tube is a stick type, the metal stick inside the tube is melted by an induction heater surrounding the lower part of the metal stick and the lower part of the tube and flows into the nozzle. As the metal stick is continuously supplied, the pressure of the metal stick itself causes the small diameter nozzle to smoothly flow the melt without stopping.

When a piece of metal or metal powder is placed inside a tube and the tube is heated by an induction heater to flow the melt into a nozzle, the upper part of the tube includes a piston to apply gas pressure to the tube so that the melt flows out of the nozzle at the lower part of the tube without stopping.

That is, the present invention provides an ultrafine powder manufacturing system characterized by including a tube made of ceramic or quartz and a nozzle integrally formed in the lower part of the tube, an induction heater that wraps around the outside of the above tube and melts a metal raw material supplied into the tube, a gas injection unit including orifices arranged to surround the nozzle at a position spaced from the above nozzle and a melt pressurizing unit installed in the upper part of the above tube to pressurize the melt, injecting gas through the gas injection unit into the melt flowing from the nozzle to manufacture ultrafine powder, and pressurizing a melt through the above melt pressurizing unit to continuously manufacture ultrafine powder without stopping.

The present invention also provides an ultrafine manufacturing system characterized by including a melting chamber, a ceramic or quartz tube placed inside the above melting chamber and a nozzle integrally formed in the lower part of the tube, an induction heater that wraps around the outside of the above tube to melt a metal stick supplied into the tube, a gas injection unit including orifices arranged to surround the nozzle while being spaced apart from the nozzle, a feeder that supplies a metal stick installed outside the chamber into a tube inside the chamber and a metal stick supplied through the feeder, also including the above gas injection unit installed on the lower surface of the chamber, the second induction heater for melting where the above induction heater is positioned lower than the first induction heater for preheating and the first induction heater, injecting gas into the melt flowing from the nozzle through the gas injection unit to manufacture ultrafine powder, and causing the supply of the above metal stick into the tube generates a pressure force on the above nozzle to continuously manufacture ultrafine powder without stopping.

In the above, the present invention provides an ultrafine powder manufacturing system characterized by including a melt pressurizing unit at the upper end of the above tube, the upper part of the melt pressurizing unit including the sealing unit formed on the chamber ceiling, and a gas inlet and a gas pressure control unit.

In the above, the present invention provides an ultrafine powder manufacturing system characterized by the fact that the lower part of a nozzle and the upper part of a gas injection unit are spaced apart by 30 to 50 mm.

In the above, the present invention provides an ultrafine powder manufacturing system characterized by the fact that the diameter of the nozzle is formed to be 0.2 to 1.0 mm.

In the above, the gas injection unit provides an ultrafine powder manufacturing system characterized by having a disc-shaped body and a funnel-shaped center, a hole in the center of the funnel-shaped center through which the melt can pass, an orifice formed through the disc-shaped body and the funnel-shaped center and an arc-shaped comb pattern that is formed on one or both of the upper and lower surfaces of the disc-shaped body and the funnel-shaped center and that creates gas passing through an orifice as vortex.

In the above, the gas injection unit provides an ultrafine powder manufacturing system characterized by the fact that the gas pressure injected through the gas injection unit is 60 to 70 bar.

In the above, the gas injection unit provides an ultrafine powder manufacturing system characterized by the fact that the pressure of the injection gas of the gas injection unit is increased as the diameter of the nozzle is reduced, thereby making the powder ultrafine.

In the above, the gas injection unit provides an ultrafine powder manufacturing system characterized by the fact that the diameter of the fine nozzle is formed to 0.2 to 1.0 mm for manufacturing ultrafine powder, and the gas pressure injected through the gas injection unit is 50 to 70 bar.

In addition, the present invention provides a metal electrode supply device that continuously supplies a metal electrode to be melted while rotating it in the metal electrode supply device applied to the ultrafine powder manufacturing system.

In other words, the present invention, which is a metal electrode supply device applied to the EIGA (Electrode Induction Gas Atomization) process, provides a metal electrode supply device characterized by including a feeder for supplying a metal electrode toward an atomizing nozzle, a rotator for rotating the metal electrode in conjunction with the feeder, and a screw connected to the above rotator for enabling the metal electrode to perform a motion of rotating and moving in a straight line by the above rotator and the feeder.

In the above, the present invention provides a metal electrode supply device characterized by the fact that the feeder comprises more than one pair of first rollers facing each other and a support supporting the first rollers.

In the above, the present invention provides a metal electrode supply device characterized by the fact that the screw comprises a pair of screw sticks facing each other, and the above rotator comprises a pair of second rollers facing each other, and a fixing part connecting each roller included in the second rollers to each screw stick.

In the above, the present invention provides a metal electrode supply device characterized by the fact that one of the pair of second rollers rotates around the +Z axis and the other rotates around the −Z axis to rotate the metal electrode, and the second rollers may include one or more pairs.

In the above, the present invention provides a metal electrode supply device characterized by the fact that the rotation speed of the rotator is controlled to 5-10 rpm.

In the above, the present invention provides a metal electrode supply device characterized by the fact that the supply speed of the feeder is controlled to 30 to 80 mm/min. for high melting point metal electrodes of 1600° C. or higher.

In the above, the present invention provides a metal electrode supply device characterized by the fact that the supply speed of the feeder is controlled to 80 to 150 mm/min. for metal electrodes having a melting point of about 1000 to 1600° C.

According to the present invention, all kinds of metals, including high-melting point metals, lightweight metals, and highly reactive metals can be continuously manufactured into ultrafine powders of 20 μm or less.

The ultrafine powder manufacturing system of the present invention can form the nozzle diameter in the lower part of the tube to a small diameter according to the desired fine powder size, and puts a metal material in the form of powder or pieces into the tube, melts it with an induction heater, and flows it into the nozzle, and applies gas pressure in the upper part of the tube, preventing clogging of the nozzle.

In addition, supplying the stick type metal to the above tube improves the flow of the melt in the nozzle and prevents clogging due to the pressure of the stick type metal itself being supplied.

In addition, the ultrafine powder manufacturing system of the present invention solves the problem of nozzle clogging by arranging the nozzle in the lower part of the tube and the orifices around the nozzle at a distance from each other to cause the injection gas supplied through the orifice to lower the temperature of the nozzle.

In addition, the injection pressure of the injection gas supplied through the orifice causes suction around the nozzle, improving the flow of the melt.

According to the present invention, the yield of ultrafine powder of 20 μm or less is 90% or more when the fine nozzle diameter is 0.5 mm, and even when the fine nozzle diameter is 2.0 mm, the yield of fine powder of 45 μm or less is very high, 90% or more.

The ultrafine powder manufacturing system of the present invention can be miniaturized or enlarged depending on the manufacturing scale, and is advantageous for ultrafine powder manufacturing of highly reactive metal materials and high melting point metal materials.

Also, according to the present invention, the metal electrode is supplied to the gas atomizer while rotating. Therefore, uneven melting of the metal electrode is prevented, thereby eliminating the problem of the metal electrode contacting the induction coil or causing short.

Thus, a high melting point, high reactivity metal electrode with a large diameter can be used, increasing the melting amount per hour, which leads to an increase in the powder production capacity.

That is, the present invention has the advantage of enabling a continuous process even in powder manufacturing using a metal electrode made of a high melting point, highly reactive material and of improving yield and productivity.

### BRIEF DESCRIPTION OF THE FIGURES

FIG. 1 is a graph that explains the purpose by powder particle size.

FIG. 2 is a cross-sectional diagram that explains powder manufacturing by conventional VIGA and EIGA.

FIG. 3 is a cross-sectional diagram that shows the configuration of an ultrafine powder manufacturing system according to the present invention.

FIG. 4 is a modified embodiment of an ultrafine powder manufacturing system according to the present invention, showing the configuration of an ultrafine powder manufacturing system that supplies a metal stick to a tube.

FIG. 5 is a graph that shows the particle-size distribution of metal powder manufactured according to the prior art and the present invention.

FIG. 6 is a SEM picture that shows the particle-size distribution of metal powder manufactured according to the present invention.

FIG. 7 is a picture of an electrode and a schematic diagram of a device that explains the problem of uneven melting caused by a conventional metal electrode supply device.

FIG. 8 is a cross-sectional diagram that shows the configuration of a metal electrode supply device according to the present invention and a picture that shows the shape of the electrode metal according to the configuration.

### DESCRIPTION OF FEATURES

Melting chamber (10)
Sealing unit (20)
Gas inlet (30)
Metal stick (40)
Metal stick feeder (50)
Tube (100)
Fine nozzle (150)
Induction heater (200)
First induction heater (210)
Second induction heater (220)
Gas injection unit (300)
Melt pressurizing unit (400)
Hole (350)
Orifice (330)
Metal electrode (510)
Chamber (520)
Feeder (600)
Rotator (700)
Screw (800)

### DETAILS BEFORE THE INVENTION

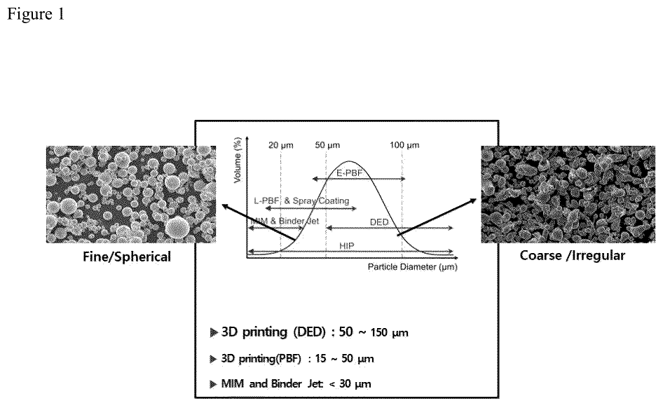

Hereinafter, a preferred embodiment of the present invention will be described in detail with reference to the attached figures. FIG. 1 explains the use according to the particle size of the metal powder. It is appropriate to use powder less than 500 μm for sintered parts, 50 to 150 μm for 3D printing (DED), 15 to 50 μm for 3D printing (PBF), and less than 30 μm for MIM and Binder Jet. In other words, fine spherical powder is required to apply metal 3D printing and MIM/Binder jet methods.

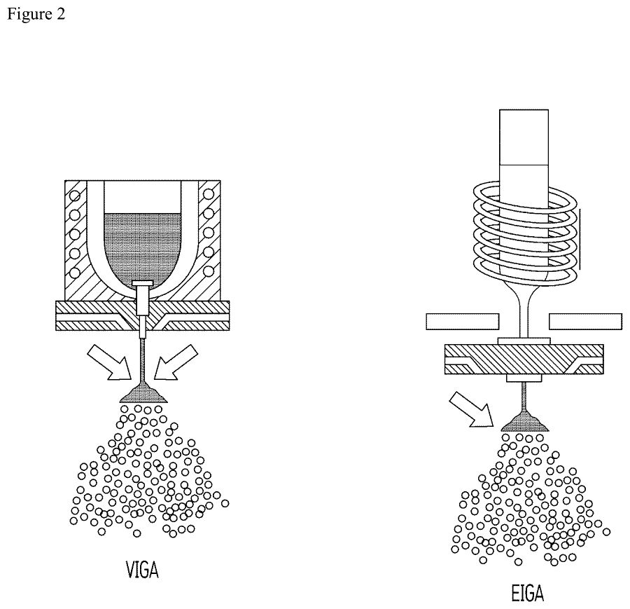

FIG. 2 is a schematic diagram that shows the explanation of the VIGA and EIGA methods.

In order to manufacture ultrafine powder in gas atomizing using a crucible and orifice, the gas pressure must be increased and the orifice diameter must be minimized.

However, if the orifice diameter is small, there is a problem that cold injection gas is sprayed from an orifice adjacent to the nozzle through which the melt flows, causing the molten metal to cool and clog within the small diameter nozzle (see the left side of FIG. 2).

Also, in order to manufacture ultrafine powder in gas atomizing not using a crucible and orifice, the gas pressure must be increased and the diameter of the melted material must be minimized. However, it is impossible to control the diameter of the melt flow melted by the induction coil, so there is a limit to manufacturing ultrafine powder in this case as well (see the right side of FIG. 2).

Therefore, the present invention proposes a new ultrafine powder manufacturing system that can obtain metal ultrafine powder having a diameter of 10-45 μm, preferably 20 μm or less, with high efficiency, enables the continuous process and can manufacture the manufacturing system to a desired size (including miniaturization).

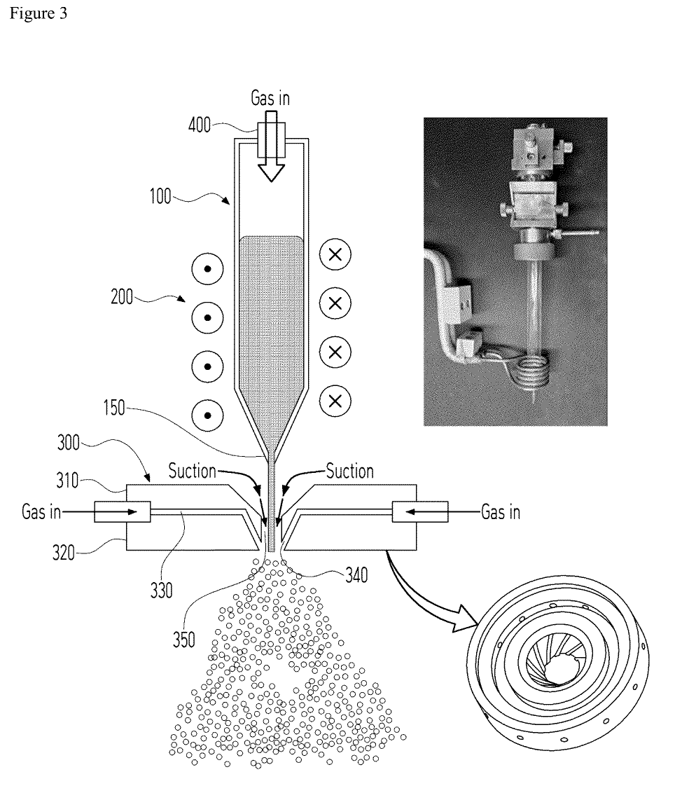

FIG. 3 shows the configuration of an ultrafine powder manufacturing system according to the present invention.

The present invention provides a ultrafine powder manufacturing system that comprises a tube made of ceramic or quartz (100) and a fine nozzle integrally formed in the lower part of the tube (150), an induction heater (200) that wraps around the outside of the tube, a melting module that melts the metal raw material supplied into the tube and causes it to flow through a fine nozzle (150), a gas injection unit (300) including orifices arranged to surround the fine nozzle while being spaced apart from the fine nozzle, a powder manufacturing module that manufactures ultrafine powder by injecting gas into flowing melt, and a melt pressurizing unit (400) that can pressurize the melt in the upper part of the tube of the melting module (100).

The melt is sprayed downward from the fine nozzle (150) of the melting module, and the melt passes through the hole (350) formed in the center of the gas injection unit (300). The gas is sprayed through the orifice (330) formed in the gas injection unit (300) to manufacture the melt into an ultrafine powder. At this time, the spray gas is high pressure and low temperature that can solidify the melt into particles, so the gas injection unit (300) must be arranged at a distance from the fine nozzle (150). The upper part of the gas injection unit (300) is arranged at a distance of about 30 to 50 mm from the lower part of the fine nozzle (150) to transmit cold air to the end of the fine nozzle (150), preventing the melt not solidifying and clogging the fine nozzle.

The diameter and length of the tube (100) can be made small or large depending on the amount of ultrafine powder to be manufactured, posing no limitation on the size. The diameter of the fine nozzle (150) formed in the lower part of the tube is set to about 0.2 to 1.0 mm for manufacturing ultrafine powder. A metal material is supplied in the form of powder or pieces to the tube and melted by an induction heater. The body diameter of the tube may be 30 to 50 mm, for example.

The lower part of the tube has a tapering shape with a gradually decreasing diameter, and the induction heater covers the part just above the fine nozzle (150), the tapered part, and the lower part of the tube. The gas injection portion (300) including the orifice comprises a hole in the center through which the melt passes, and the orifice (330) formed by penetrating the center of the body has a comb-like pattern forming a spiral or arc on one or both sides of the inner surface of the upper body (310) and the lower body (320) to make the gas passing through the orifice a vortex. In other words, the upper surface (inner surface of the upper body (310)) and/or the lower surface (inner surface of the lower body (320)) of the orifice through which the gas passes has a comb-like pattern.

The center of the gas injection unit (300) is formed in a funnel shape, and the structure of the orifice is also formed accordingly.

That is, the gas injection unit has a disc-shaped body and a funnel-shaped center, a hole in the center of the funnel-shaped center through which a melt can pass, an orifice formed by penetrating the center of the disc-shaped body and the funnel shape, and an arc-shaped comb-shaped pattern formed on one or both of the upper and lower surfaces of the center of the disc-shaped body and the funnel shape to create gas passing through the orifice a vortex.

The gas injected toward the orifice from the outside of the gas injection unit (300) is an inert gas, and the injection pressure is 50 to 70 bar. The temperature of the injected gas is −20 to 500° C.

A melt pressurizing unit (400) is arranged in the upper part of the tube.

There is a gas chamber connected to a gas cylinder to supply gas and a pressure control unit that can control the pressure of the gas, and the gas pressure can be controlled according to the tube capacity, the amount of molten metal, and the molten metal flow rate. In this embodiment, the pressure of about 0.5 bar was applied. The melt introduced into the micro nozzle (150) can continuously flow due to the pressure of the melt pressurizing unit. That is, a fine nozzle with fine diameter may cause the melt to not flow out easily and to stagnate or become clogged, but the present invention solves this problem by applying gas pressure.

The gas used for pressurizing the melt in the upper part of the tube is inert gas such as Ar, He, or N2, and a gas mixed with these may be used.

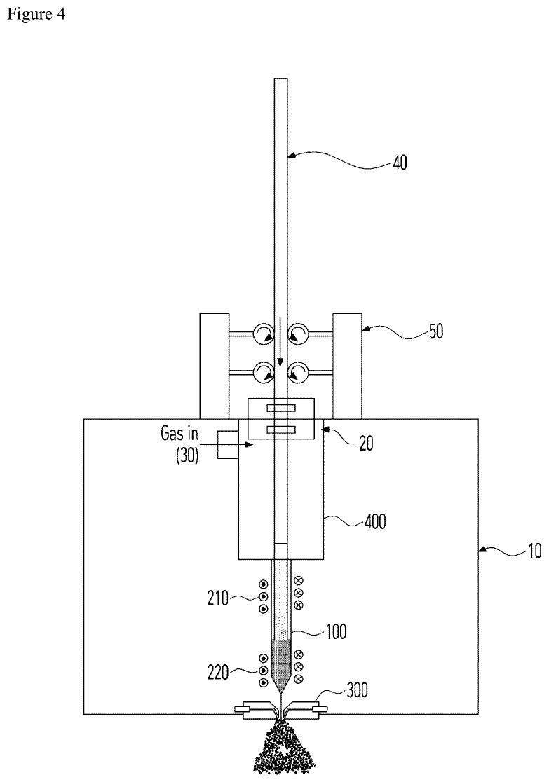

FIG. 4 shows a modified embodiment of the present invention.

In FIG. 4, the metal material supplied to the tube (100) is a metal stick (i.e., a metal electrode). In this configuration, the metal stick supply itself provides a pressure force to the fine nozzle (150) in the lower part of the tube, so the melt pressurizing unit (400) can be optional rather than mandatory, unlike in FIG. 3.

A tube (100), an induction heater (210, 220), and a gas injection unit (300) are formed inside a melting chamber (10), and a metal stick feeder (50) is installed in the upper part of the chamber to supply a metal stick (40) to the tube (100) inside the chamber.

A melt pressurizing unit (400) is formed in the upper part of the tube (optional), and the upper part of the melt pressurizing unit (400) includes a scaling unit (20) and a gas inlet (30) on the chamber ceiling. The gas injection unit (300) is installed at the bottom of the chamber, and the ultrafine powder manufactured is emitted from the bottom of the chamber.

The diameter of the fine nozzle (150) is approximately 0.2 to 1.0 mm, and the diameter of the tube (100) is configured to have a margin for the diameter of the metal rod (40), and may be 30 to 200 mm.

When the metal stick (40) is supplied to the tube, the induction heater surrounding the tube includes the first induction heater for preheating (210) and a second induction heater for melting (220) located further down from the first induction heater. The second induction heater (220) is installed at a location that wraps around the tapered portion in the lower part of the tube. Preheating by the first induction heater and melting by the second induction heater improves the flow speed of the continuous process, and the heat capacity of the second induction heater can be fully used for melting without flowing back up to the metal stick.

Both the gas used for pressurization in the melt pressurizing unit (400) in the upper part of the tube and the gas injected through the orifice of the gas injection unit (300) below the nozzle are inert gases (e.g., Ar). FIG. 3 shows the specific configuration of the gas injection unit (300). In addition, the spacing between the fine nozzle (150) and the gas injection unit (300) is also as shown in FIG. 3. That is, in this embodiment where a modification is applied to the melting module, the powder manufacturing module is the same, and the melting module is placed in a separate vacuum chamber.

The gas injection pressure injected from the gas injection unit (300) may be 50 to 70 bar, and the gas temperature is about −20 to 500° C.

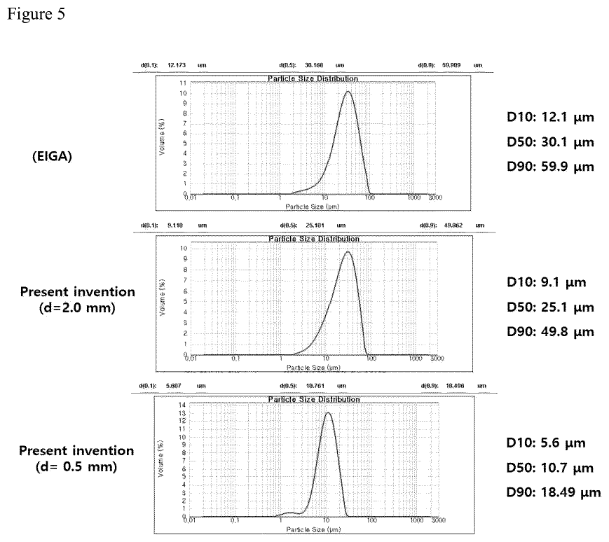

FIG. 5 is a graph that shows the particle-size distribution of metal powder manufactured according to the prior art and the present invention.

The metal material is a soft magnetic alloy, and the ultrafine soft magnetic alloy powder has a small particle size, thereby exhibiting a higher amorphous forming ability, which improves the soft magnetic properties.

When powder is manufactured using the conventional EIGA method, D10 is 12.1 μm, D50 is 30.1 μm, and D90 is 59.9 μm, and ultrafine powder of 20 μm or less accounts for less than 30% of the entire powder, showing a low yield of about 10%. In the case of the ultrafine powder manufacturing system of the present invention, when the fine nozzle diameter d is 2.0 mm, D50 is 25.1 μm, D10 is 9.1 μm, and D90 is 49.8 μm, and ultrafine powder of 20 μm or less accounts for close to 50% of the entire powder.

When the fine nozzle diameter is 0.5 mm, D50 is 10.7 μm, D10 is 5.6 μm, and D90 is 18.49 μm, showing a high yield with ultrafine powder of less than 20 μm accounting for over 90% of the total powder. Therefore, the ultrafine powder manufacturing system of the present invention provides ultrafine powder of 20 μm or less with a significantly improved yield compared to the prior art.

In the above, the values for the fine nozzle diameter are 0.5 mm and 2.0 mm, which are embodiments, and they can be changed to any value in between. At this time, the gas injection pressure of the gas injection unit must be adjusted in conjunction with the fine nozzle diameter. The larger the fine nozzle diameter, the higher the gas injection pressure, which makes the particle size smaller. The particle size can be also adjusted in conjunction with the pressing force of the melt pressurizing unit (400), and the smaller the diameter of the fine nozzle, the greater the pressing force of the melt pressurizing unit (400).

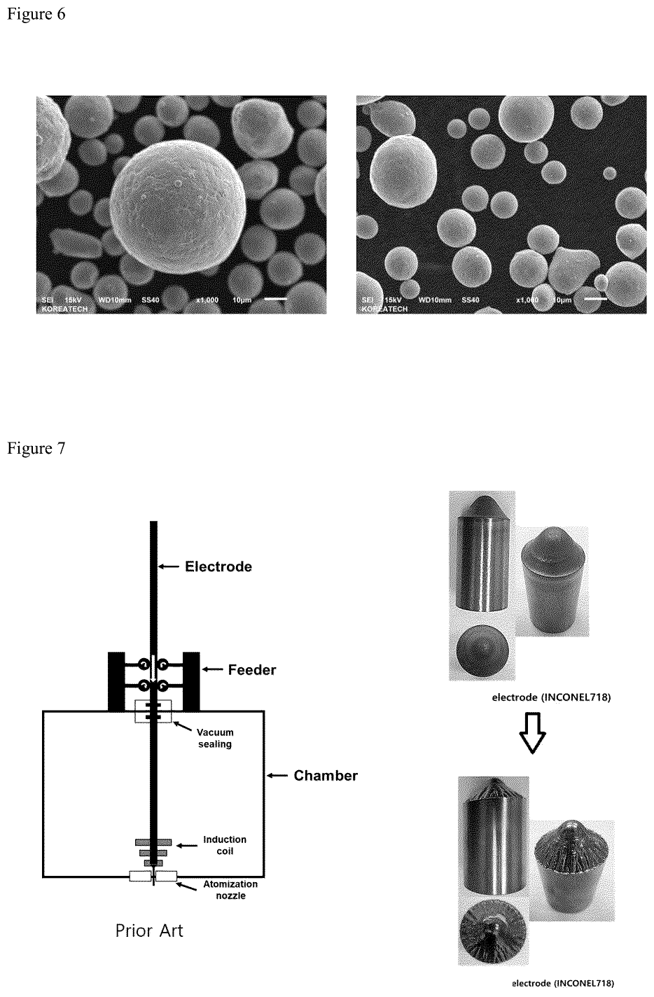

FIG. 6 is a SEM picture that shows the particle size distribution of metal powder manufactured according to the present invention. It can be seen that when the material is Eloi-A1, (the Eloi A1 composition is in atomic percent (at. %) 77.5Fe-6Si-14.5B-2C), the injection gas pressure is 65 bar, and the nozzle diameter is 2.0 mm (left) and 0.5 mm (right), most of the manufactured ultrafine powders are spherical and there is almost no satellite powder.

As shown above, a system can be implemented that can manufacture ultrafine powder of highly reactive materials and high melting point materials with a high yield.

On the other hand, it is advantageous for the diameter of the metal electrode to be large in order to improve productivity in the EIGA method. However, when a metal electrode with a large diameter is used in a conventional metal electrode supply device, uneven melting of the metal electrode occurs.

FIG. 7 is a schematic diagram of a device and a picture of an electrode illustrating the problem of uneven melting caused by a conventional metal electrode supply device.

Since a typical metal electrode supply device has a feeder that advances the electrode into a lower vacuum chamber, the metal electrode advances straight into the vacuum chamber and is heated and melted by an induction coil (This also applies to the above FIG. 4). A pair of facing rollers are provided, and the metal electrode is placed between the rollers and advances straight downward by the rotational motion of the rollers on both sides. In the case of an EIGA system that applies a metal electrode supply device of this configuration, there are problems of contact and short between the metal electrode and the induction coil. FIG. 7 shows the uneven melting of the metal electrode due to the manufacturing of metal powder. This uneven melting of the electrode occurs because melting at the tapered end of the metal electrode does not occur uniformly at the outer part of the end. That is, among the areas heated by the eddy current, a concentrated melting area occurs locally in a part where heat dissipation has not occurred, and this melting area pushes out the melt by the Lorentz force and gravity to form grooves.

To solve this problem, the inventors of the present invention have constructed a novel metal electrode supply device that supplies a metal electrode while rotating it.

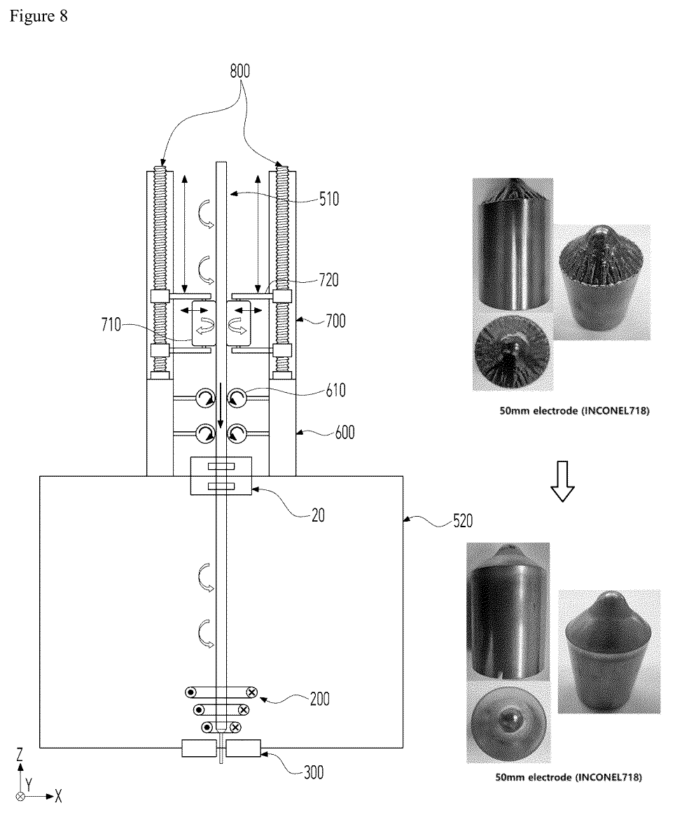

FIG. 8 is a cross-sectional diagram that shows the configuration of a metal electrode supply device according to the present invention and a picture that shows the shape of the electrode metal accordingly.

A metal electrode supply device according to the present invention includes a feeder (600) that supplies a metal electrode (510) in a straight direction toward a vacuum chamber (520) where an atomizer nozzle is installed, a rotator (700) that is connected to the feeder (600) to rotate the metal electrode (510), and a screw (800) that provides a function of allowing the rotator (700) to rotate the metal electrode while moving in a straight direction.

In other words, the feeder (600) has a pair of facing first rollers (610) each fixed to a pair of facing supports having a Z-axis component, and a metal electrode passes through the roller gap, and the pair of first rollers rotate around the Y-axis as a rotation axis (one clockwise, the other counterclockwise) to move the metal electrode straight along the Z-axis (goes straight in the −Z direction). The number of first rollers included in the feeder may be one or more pairs, and the present embodiment consists of two pairs. An end of a screw (800) is connected to the feeder (600) support, and the screw (800) forms a screw housing and is placed therein. The housing may be omitted, and the screw (800) rotates.

The above screw (800) is also composed of a pair of facing screw bars, and a pair of second rollers (710) that are fixed with a fixing part (720) to each screw bar are installed to form a rotator (700).

One of the second rollers that rotates the metal electrode (510) around the Z-axis rotates around the +Z-axis and the other rotates around the −Z-axis to rotate the metal electrode (510). At this time, the metal electrode (510) should perform a rotational motion around the Z-axis and a linear motion toward the −Z-axis, so the second roller is connected and fixed to a screw (800) that has rotation and transport functions to enable such motions. In addition, the second rollers constituting the rotator (700) may include one or more pairs.

Such rotator (700) configuration eliminates the uneven melting that has occurred in conventional metal electrodes. The uneven melting problem mainly occurs in metal electrodes with a high melting point (over 1400° C.) and a large diameter, and the rotation speed by the rotator can be controlled according to the melting point, reactivity, and diameter of the metal electrode. In addition, the rotation speed of the rotator and the supply speed of the feeder can be controlled together.

The rotation speed of the rotator can be controlled to 5 to 10 rpm for metals having high melting points and low thermal conductivity, such as Ti, Mo, and Nb, or metal electrodes containing such components.

For a high melting point metal electrode of 1600° C. or higher, it is desirable to set the feeder supply speed to 30 to 80 mm/min. For a metal electrode having a melting point of about 1000 to 1600° C., the feeder supply speed can be controlled to 80 to 150 mm/min.

According to the present invention, even if the EIGA method is performed using a high-melting point metal with a fully large diameter, there is no problem of contact or short between the electrode and the induction coil due to uneven melting of the electrode, enabling a continuous process. This has the advantages of improved productivity and reduced manufacturing costs.

Unless otherwise defined in the above, all technical and scientific terms used in this specification have the same meaning as commonly understood by a skilled expert in the technical field to which the present invention belongs. Also, terms defined in commonly used dictionaries should not be ideally or excessively interpreted, unless explicitly specifically defined. When a part throughout the specification is “include” or “have” a certain component, this means that, unless otherwise specifically stated, it may include other components rather than excluding them. In addition, the singular may include the plural depending on the context.

Also, in this specification, the term “inside” includes cases where an object is directly placed inside a target object, as well as cases where there is another part in between.

Also, in this specification, “on, above, or upper par” means locating above or below a target part, and does not necessarily mean locating above based on the direction of gravity, and includes not only cases where the target parts are in contact with or spaced apart from each other, but also cases where there is another part in between.

Also, in this specification, “below, under, or lower part” means locating below the target part, and does not necessarily mean locating lower based on the direction of gravity, and includes not only cases where the target parts are in contact or spaced apart, but also cases where there is another part in between.

The rights of the present invention are not limited to the embodiments described above, but are defined by what is described in the claims, and it is obvious that a person of ordinary skill in the pertinent art in the field of the present invention can make various modifications and adaptations within the scope of the rights described in the claims.

What is claimed is:

1. An ultrafine powder manufacturing system comprising a tube made of ceramic or quartz and a nozzle integrally formed in the lower part of the tube, an induction heater that wraps around the outside of the tube and melts a metal raw material supplied into the tube, a gas injection unit including orifices arranged to surround the nozzle at a position spaced from the nozzle and a melt pressurizing unit installed in the upper part of the tube to pressurize the melt, injecting gas through the gas injection unit into the melt flowing from the nozzle to manufacture ultrafine powder, and pressurizing a melt through the melt pressurizing unit to continuously manufacture ultrafine powder without stopping.

2. An ultrafine manufacturing system comprising a melting chamber, a ceramic or quartz tube placed inside the melting chamber and a nozzle integrally formed in the lower part of the tube, an induction heater that wraps around the outside of the tube to melt a metal stick supplied into the tube, a gas injection unit including orifices arranged to surround the nozzle while being spaced apart from the nozzle, a feeder that supplies a metal stick installed outside the chamber into a tube inside the chamber and a metal stick supplied through the feeder, the gas injection unit installed on the lower surface of the chamber, the second induction heater for melting where the above induction heater is positioned lower than the first induction heater for preheating and the first induction heater, injecting gas into the melt flowing from the nozzle through the gas injection unit to manufacture ultrafine powder, and causing the supply of the metal stick into the tube generates a pressure force on the nozzle to continuously manufacture ultrafine powder without stopping.

3. The system according to claim 1 wherein the upper part of the tube includes a melt pressurizing unit, and the upper part of the melt pressurizing unit includes a sealing unit formed on the chamber ceiling and includes a gas inlet and a gas pressure control unit.

4. The system according to claim 1, wherein the lower part of the nozzle and the upper part of the gas injection unit are spaced at a distance of 30 to 50 mm.

5. The system according to claim 2, wherein the lower part of the nozzle and the upper part of the gas injection unit are spaced at a distance of 30 to 50 mm.

6. The system according to claim 1, wherein the nozzle has a diameter of 0.2 to 1.0 mm.

7. The system according to claim 2, wherein the nozzle has a diameter of 0.2 to 1.0 mm.

8. The system according to claim 1, wherein the gas pressure injected through the gas injection unit is 60 to 70 bar.

9. The system according to claim 2, wherein the gas pressure injected through the gas injection unit is 60 to 70 bar.

10. The system according to claim 1, wherein the smaller the diameter of the nozzle, the more the pressure of the injected gas from the gas injection unit is increased to make the powder ultrafine.

11. The system according to claim 2, wherein the smaller the diameter of the nozzle, the more the pressure of the injected gas from the gas injection unit is increased to make the powder ultrafine.

12. The system according to claim 1, wherein the diameter of the nozzle is formed to be 0.2 to 1.0 mm for ultrafine powder manufacturing and the gas pressure injected through the gas injection unit is 50 to 70 bar.

13. The system according to claim 2, wherein the diameter of the nozzle is formed to be 0.2 to 1.0 mm for ultrafine powder manufacturing and the gas pressure injected through the gas injection unit is 50 to 70 bar.

14. A metal electrode supply device applied to an EIGA (Electrode Induction Gas Atomization) process, comprising a feeder that supplies a metal electrode toward an atomizing nozzle, a rotator that rotates the metal electrode in conjunction with the feeder, and a screw connected to the rotator for enabling the metal electrode to perform a motion of rotating and moving in a straight line by the rotator and the feeder.

15. The system according to claim 14, wherein the feeder includes one or more pairs of first rollers facing each other and a support supporting the first rollers.

16. The system according to claim 14, wherein the screw comprises a pair of screw sticks facing each other, the above rotator comprises a pair of second rollers facing each other, and a fixing part connecting each roller included in the second rollers to each screw stick.

17. The system according to claim 14, wherein one of the pair of second rollers rotates around the +Z axis and the other rotates around the −Z axis to rotate the metal electrode.

18. The system according to claim 14, wherein the rotation speed of the rotator is controlled to 5 to 10 rpm.

19. The system according to claim 14, wherein the supply speed of the feeder is controlled to 30 to 80 mm/min for a high melting point metal electrode having a melting point of 1600° C. or higher.

20. The system according to claim 14, wherein the supply speed of the feeder is controlled to 80 to 150 mm/min. for a metal electrode having a melting point of approximately 1000 to 1600° C.
